(19) United States
(12) Patent Application Publication
(10) Pub. No.: US 2004/0232073 A1
(43) Pub. Date: Nov. 25, 2004

(54) Bulk separation of semiconducting and metallic single wall nanotubes

(76) Inventor: Fotios Papadimitrakopoulos, Coventry, CT (US)

Correspondence Address: CANTOR COLBURN LLP, 55 Griffin Road South, Bloomfield, CT, 06002, US

(21) Appl. No.: 10/775,566

(22) Filed: Feb. 10, 2004

Related U.S. Application Data
(60) Provisional application No. 60/446,393, filed on Feb. 10, 2003.

(51) Int. Cl. B01D 11/00

(52) U.S. Cl. 210/634; 210/639; 210/702; 210/723

(57) ABSTRACT

A method is described to bulk separate single wall nanotubes (SWNTs) by type (metallic (met-) from semiconducting (sem-)) and diameter. The separation is based on selective precipitation of either sem-SWNTs or met-SWNTs from a population of functionalized SWNTs surfactant N-alkyl-amines, for example, preferentially solubilize sem-SWNTs and precipitate met-SWNTs, while non-surfactant amines to selectively precipitate sem-SWNTs, leaving the met-SWNT fraction in suspension. In addition, the selective precipitation method can be used to separate enriched populations of sem-SWNTs or met-SWNTs by diameter.

### CROSS-REFERENCE TO RELATED APPLICATIONS

This application claims the benefit of U.S. Provisional Application Serial No. 60/446,393 filed Feb. 10, 2003, which is fully incorporated herein by reference.

### STATEMENT REGARDING FEDERALLY SPONSORED RESEARCH AND DEVELOPMENT

The U.S. government may have certain rights to this invention pursuant to NSF (National Science Foundation) grant No. DMR-970220, AFOSR (Airforce Office of Scientific Research) subcontract No. Y-301703, AFOSR grant No. F49620-01-1-0545 and ARO (Army Research Office) grant No. DAAD-19-02-1-0381.

### BACKGROUND

Single wall nanotubes (SWNTs) (e.g., single wall carbon nanotubes) form a unique class of one-dimensional quantum confined structures exhibiting either semiconducting (sem) or metallic (met-) behavior. From an electronics perspective, separation of SWNTs according to type (met- from sem-) may be critical for certain applications, while separation by diameter for sem-SWNTs may be of paramount importance in the microelectronics arena (e.g., because diameter governs their band-gap). A significant innovation in this direction, albeit destructive, involves the current-induced break down of carbon nanotubes, whereby met-SWNTs can be selectively burnt off. Precise control over the type (met- versus sem-) and diameter during the SWNT growth at present remains a challenge and the post synthesis separation appears the most feasible venue to accomplish such task. Post-synthesis separation, however, is associated with an array of challenges stemming from SWNT aggregation that is further compounded by SWNT chemical inertness. Existing SWNT solubilization methodologies include either nanotube functionalization or nanotube micellarization with the help of low and high molecular weight surfactants. Among these surfactants, N-alkylamines, and in particular octadecylamine (ODA), were shown to be capable of dispersing SWNTs as well as permitting their length separation via gel-permeation chromatography (U.S. patent application No. 2003/0168385).

### SUMMARY OF THE INVENTION

A method of separating met-SWNTs from sem-SWNTs comprises suspending a population of functionalized SWNTs in a suspending solvent, and employing a means for inducing selective precipitation, wherein selective precipitation comprises precipitating a majority of the met-SWNTs while leaving a population of the sem-SWNTs in suspension, or precipitating a majority of the sem-SWNTs while leaving a population of the met-SWNTs in suspension.

A method for selective extraction of sem-SWNTs from a mixture of sem-SWNTs and met-SWNTs comprises contacting a population of non-acid functionalized SWNTs with a surfactant amine to produce a population of surfactant amine functionalized sem-SWNTs, and extracting the population of surfactant amine functionalized sem-SWNTS with a means for extraction while leaving a majority of the met-SWNT behind.

A method of separating sem-SWNTs or met-SWNTs by diameter to form a diameter-separated population of sem-SWNTs or met-SWNTs comprises suspending an enriched population of functionalized sem-SWNTs or an enriched population functionalized met-SWNTs in a suspending solvent to form a functionalized sem-SWNT suspension or a functionalized met-SWNT suspension, and employing a means for selectively precipitating according to diameter the functionalized sem-SWNT suspension or the functionalized met-SWNT suspension, wherein the enriched population of functionalized sem-SWNTs comprises greater than or equal to about 66 wt % sem-SWNTs or the enriched population of functionalized met-SWNTs comprises greater than or equal to about 66 wt % met-SWNTs.

### BRIEF DESCRIPTION OF THE DRAWINGS

Referring now to the exemplary drawings wherein like elements are numbered alike in the several FIGURES:

FIG. 1 shows a schematic of the dispersion of surfactant N-alkyl-amines (e.g. octadecylamine) on acid functionalized SWNTs solely by the formation of zwitterions.

FIG. 2 shows a schematic of the dispersion of surfactant N-alkyl-amines (e.g. octadecylamine) on acid functionalized SWNTs through the organization of octadecylamine on the SWNTs in addition to the zwitterions.

FIG. 3 shows differential scanning calorimetric (DSC) scans of the as obtained octadecylamine (ODA) (A, solid line); and a scan obtained after heating ODA for 18 hrs at 68° C. (B, dashed line).

FIG. 4 shows typical DSC scans for SWNT/ODA complexes of laser-ablated and HiPco SWNTs.

FIG. 5 illustrates the 514 nm (2.41 eV) resonance Raman spectra of the radial breathing mode (RBM) (top-left panel) and G-band (right panel) of the as-supplied, precipitate and supernatant fractions (from bottom to top) of HiPco SWNTs, following the complete removal of any remaining ODA and THF residues.

FIG. 6 shows the Anti-Stokes resonance Raman spectra for laser-ablated SWNTs with the 785 nm (1.58 eV) laser excitation for the as-supplied (I), dispersed-before-precipitation (II), supernatant (III), and precipitate (IV) SWNT fractions.

FIG. 7 illustrates the 514 nm (2.41 eV) resonance Raman spectra of the radial breathing mode (RBM) (bottom curves) and G-band (insert) of the supernatant fractions of HiPco SWNTs.

FIG. 8 illustrates the 514 nm (2.41 eV) resonance Raman spectra of the radial breathing mode (RBM) (top-left panel) and G-band (right panel) of the starting sample (acid-treated and annealed), precipitate, and supernatant fractions (from bottom to top) of HiPco SWNTs.

FIG. 9 illustrates the radial breathing mode (RBM) Raman spectra of DMF-dispersed HiPco SWNTs obtained with a 785 nm (1.58 eV) excitation laser for increasing amount of added dimethylarnine.

### DETAILED DESCRIPTION

Carbon nanotubes are elongated tubular bodies that are composed of a plurality of cylindrically rolled graphite films that are arranged telescopically. Nanotubes can be either single wall nanotubes (SWNTs) or multi wall nanotubes (MWNTs). A preferred nanotube is a single wall nanotube. Single wall nanotubes can further be subdivided into metallic (met-SWNTs) or semiconducting (sem-SWNTs).

Because semrSWNTs and met-SWNTs have uses in different applications, it is desirable to separate sem-SWNTs and met-SWNTs. A method of separating met-SWNTs from sem-SWNTs comprises suspending a population of functionalized SWNTs in a suspending solvent, and employing a means for inducing selective precipitation, wherein selective precipitation comprises precipitating a majority of the met-SWNTs while leaving a population of the sem-SWNTs in suspension, or precipitating a majority of the sem-SWNTs while leaving a population of the met-SWNTs in suspension. By employing suitable combinations of SWNT suspensions and means for inducing selective precipitation, the sem-SWNTs or the met-SWNTs may be preferentially precipitated.

Carbon nanotubes are primarily carbon, although the nanotube fiber may have a number of other atoms, such as boron, nitrogen, and the like. The raw material carbon used to produce nanotubes may be fullerenes, metallofullerenes, graphite, including carbon black, hydrocarbons, including paraffins, olefins, diolefins, ketones, aldehydes, alcohols, ethers, aromatic hydrocarbons, diamonds, another compound that comprises carbon, or a combination comprising one or more of the foregoing raw materials. Specific hydrocarbons useful for forming carbon nanotubes include methane, ethane, propane, butane and higher paraffins and isoparaffins, ethylene, propylene, butene, pentene and other olefins and diolefins, ethanol, propanol, acetone, methyl ethyl ketone, acetylene, benzene, toluene, xylene, ethylbenzene, benzonitrile, and combinations comprising one or more of the foregoing materials.

Nanotubes may have diameters of about 0.5 nanometer (run) for a single wall nanotube to about 3 nm, about 5 nm, about 10 nm, about 30 nm, about 60 nm, or about 100 nm for single wall or multi wall nanotube. The nanotubes may have a length of about 50 nm up to about 1 millimeter (mm), about 1 centimeter (cm), about 3 cm, about 5 cm, or greater.

SWNTs have limited solubility, and thus may be difficult to put into solution or suspension. One method to improve the solubility of a SWNT is to functionalize the nanotube. One suitable means of functionalization is acid functionalization. Acid functionalization may optionally be followed by functionalization with an amine such as an surfactant N-alkyl-amine.

Acid functionalization (i.e., carboxy functionalization) of SWNTs can be accomplished by incubating the SWNTs in acid for a time and at a temperature sufficient to produce the desired level of acid functionalization in the population of SWNTs. Acid functionalization may optionally be accompanied by and/or followed by sonication. Preferred acids are mineral acids such as H₂SO₄, HNO₃, and combinations comprising one or more of the foregoing acids. A suitable acid functionalization protocol is treating the SWNTs with a (7:3) mixture of HNO₃:H₂SO₄, for 6 hours at temperatures of about 40 to about 100° C., preferably about 40 to about 60° C. Alternative means of introducing carboxy functionalization include, for example, treatment with oxygen (at elevated temperatures, e.g., at about 400° C.), or treatment with hydrogen peroxide (e.g., at about 40° C. to about 100° C.).

Suitable suspending solvents for use with acid functionalized SWNTs include polar solvents such as, for example, dimethylformamide (DMF), dimethylacetamide (DMAC), formamide, methyl formamide, hexamethylenephosphormamide, dimethylsulfoxide (DMSO), and combinations comprising one or more of the foregoing suspending solvents.

SWNTs, either acid functionalized or not, may be treated with a surfactant amine, for example, an N-alkyl-surfactant amine such as octadecylamine (ODA). Other surfactant N-alkyl-amines include primary, secondary, and tertiary amines with varying numbers of carbon atoms and functionalities in their surfactant alkyl chains. Suitable N-alkyl amines include, but are not limited to, butyl-, sec-butyl-, tert-butyl-, pentyl-, hexyl-, heptyl-, octyl-, nonyl-, decyl-, dodecyl-, tetradecyl-, hexadecyl-, eicosadecyl-, tetracontyl-, pentacontyl-amines, 10,12-pentacosadiynoylamine, 5,7-eicosadiynoylamine, and combinations comprising one or more of the foregoing amines. In addition, alkyl-aryl amines such as, for example, benzyl amine, aniline, phenethyl amine, N-methylaniline, N,N-dimethylaniline, 2-amino-styrene, 4-pentylaniline, 4-dodecylaniline, 4-tetradecylaniline, 4-pentacosylaniline, 4-tetracontylaniline, 4-pentacontylaniline, and combinations comprising one or more of the foregoing amines, may be employed.

Surfactant amine functionalization may comprise mixing the single wall nanotubes with the surfactant amine without solvent or in an appropriate solvent (e.g., a nonpolar solvent such as toluene, chlorobenzene, dichlorobenzene, and combinations comprising one or more of the foregoing solvents), and preferably the heating the mixture to a temperature of about 50° to about 200° C., more preferably about 90° C. to about 105° C. Each surfactant N-alkyl-amine may have at least two melting transitions, a low temperature transition (e.g., about −20° C. to about 50° C.) and a high temperature transition (e.g., about 30 to about 110° C.). Without being held to theory, it is believed that surfactant N-alkyl-amine functionalization of SWNTs at a temperature near the higher melting point transition of the surfactant N-alkyl-amine improves the organization of the surfactant N-alkyl-amine on the SWNTs and also improves the separation efficiency. The heating is preferably maintained for a time sufficient for the reaction to achieve substantial completion, such as reaction for about 96 hours. By substantial completion, it is meant that further incubation results in less than or equal to about 5% additional functionalization.

Preferably, after surfactant amine functionalization, the functionalized SWNTs are washed to remove excess surfactant amine. Suitable solvents for washing include, for example, ethanol, ethylacetate, ethers, aliphatic ethers, aliphatic hydrocarbons, and combinations comprising one or more of the foregoing solvents. Washing is preferably performed to an extent that the functionalized nanotubes may subsequently be suspended in the suspending solvent. For example, too little washing or excess washing may be detrimental to suspension of the functionalized nanotubes and to the subsequent separation.

Suitable suspending solvents for use with surfactant amines include non-polar solvents such as, for example, an ether, an acetate, an aliphatic hydrocarbon, an aromatic hydrocarbon, a chlorinated solvent, or a combination comprising one or more of the foregoing solvents. A preferred solvent for use with the surfactant N-alkyl-amines is tetrahydrofuran (THF).

Once the suspension of functionalized SWNTs is formed, a means for selective precipitation is employed to selectively precipitate either the sem-SWNTs or the met-SWNTs from the suspension. Suitable means for selective precipitation affect the stability of the functionalized SWNTs and preferably facilitate the precipitation of either sem-SWNTs or met-SWNTs.

Suitable means for selective precipitation of met-SWNTs or sem-SWNTs from a mixed population of SWNTs include, for example, solvent evaporation, centrifugation, increasing the temperature of the suspension, decreasing the temperature of the suspension, or adding a component such as, for example, a non-solvent, a solvent with a high dielectric constant, a salt, an acid, a compound that provides complexing cations, a solvent with hydrocarbon solubilizing strength, a reducing medium, an oxidizing medium, and combinations comprising one or more of the foregoing means. Suitable solvents with a high dielectric constant include, for example, dimethylformamide, hexamethylphosphoramide, dimethylsulfoxide, and the like, and combinations comprising one or more of the foregoing solvents. The solvents with a high dielectric constant preferably affect the zwitterionic solubilization strength. Suitable salts include, for example, NaCl, KCl, NaBr, KBr, LiF, lithium acetate, sodium acetate, and the like, and combinations comprising one or more of the foregoing salts. The salts preferably affect the zwitterionic solubilization strength. Suitable acids include, for example, hydrochloric, acetic, nitric, sulfuric, oxalic, acetic, benzoic, oxalic, and the like, and combinations comprising one or more of the foregoing acids. Suitable compounds that provide complexing cations include, for example, calcium acetate, zinc acetate, magnesium acetate, aluminum acetate, and the like, and combinations comprising one or more of the foregoing compounds. Suitable solvents with aliphatic hydrocarbon solubilizing strength include, for example, methylene chloride, hexane, octane, and combinations comprising one or more of the foregoing solvents. The solvents with hydrocarbon solubilizing strength preferably affect the organization stability of the amine-based surfactant media. Suitable reducing media include, for example, lithium borohydride, calcium hydride, hydrogen, and the like, and combinations comprising one or more of the foregoing reducing media. The reducing media preferably affect the oxidation content of SWNTs affect the oxidation content of SWNTs. Suitable oxidizing media include, for example, HNO₃, H₂O₂, KMnO₄, and the like, and combinations comprising one or more of the foregoing oxidizing media. The oxidizing media preferably affect the oxidation and doping content of SWNTs.

Suitable means for precipitating sem-SWNTs from an acid functionalized population of sem-SWNTs and met-SWNTs in suspension in polar solvent also include the addition of a non-surfactant amine. Non-surfactant amines are herein defined as amines which, although they may optionally possess amphiphilic character, can interact with more that one nanotube at the same time. Non-surfactant amines include, for example, low molecular weight amines, α,ω-alkyl-diamines, multifunctional amines, and combinations comprising one or more of the foregoing amines. Suitable low molecular weight amines include, for example, methyl-, ethyl-, propyl-, isopropyl- butyl-amines, N,N-dimethyl-, N,N-methylethyl, N,N-diethyl-, N,N-ethylpropyl-, N,N-dipropyl-amines, and combinations comprising one or more of the foregoing amines. Suitable α,ω-alkyl-diamines include, but are not limited to, ethylene-, propylene-, butylene-, pentylene-, hexylene-, heptylene-, octylene-, nonylene-, decylene-, dodecylene-, tetradecylene-, hexadecylene-, eicosadecylene-, tetracontylene-, pentacontylene-α,ω-diamines, 10,12-pentacosadiynoylene-α,ω-diamine, 5,7-eicosadiynoylene-α,ω-diamine, and combinations comprising one or more of the foregoing amines. In addition alkyl/aryl amines and diamines such as, for example piperazine, 1,4-phenylenediaamine, p-xylylenediamine, and combinations comprising one or more of the foregoing amines may be employed. Suitable multifunctional amines include, for example, pentaethylenehexamine, triethylenetetraamine, N,N′-bis(3-aminopropyl)-1,3-propanediamine, N,N′-bis(3-aminopropyl)-1,3-butanediamine, and combinations comprising one or more of the foregoing multifunctional amines.

A method of selectively precipitating met-SWNTs while leaving the sem-SWNTs in the suspension comprises treating a suspension of carboxy and surfactant amine functionalized SWNTs with a means for selective precipitation. Without being held to theory, it is believed that amines physisorb more tightly to sem-SWNTs than met-SWNTs. Thus, when a means for selective precipitation is employed to destabilize the suspension of surfactant amine functionalized sem-SWNTs and met-SWNTs, met-SWNTs are preferentially precipitated, while a population of the sem-SWNTs remain in suspension. While a population of the sem-SWNTs remains in suspension, a fraction of the sem-SWNTs may precipitate with the met-SWNTs, for example, because of aggregation in the suspension. Such aggregates are likely to precipitate upon employing a means for selective precipitation. The enrichment that may be achieved by this method is preferably greater than or equal to 2-fold enrichment of the soluble SWNT population for sem-SWNTs, preferably greater than or equal to about 4-fold enrichment, more preferably greater than or equal to about 8-fold enrichment, and most preferably greater than or equal to about 100-fold enrichment.

Repeating the precipitation with a sem-SWNT-enriched fraction may further improve the separation efficiency. By establishing an optimum acid and amine functionalization content for both met- and sem-SWNTs, dispersion and thus the level of purification can be improved.

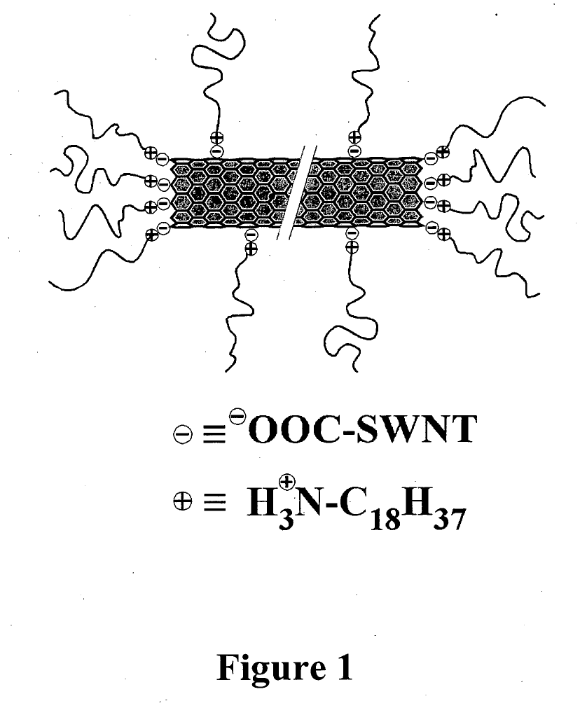

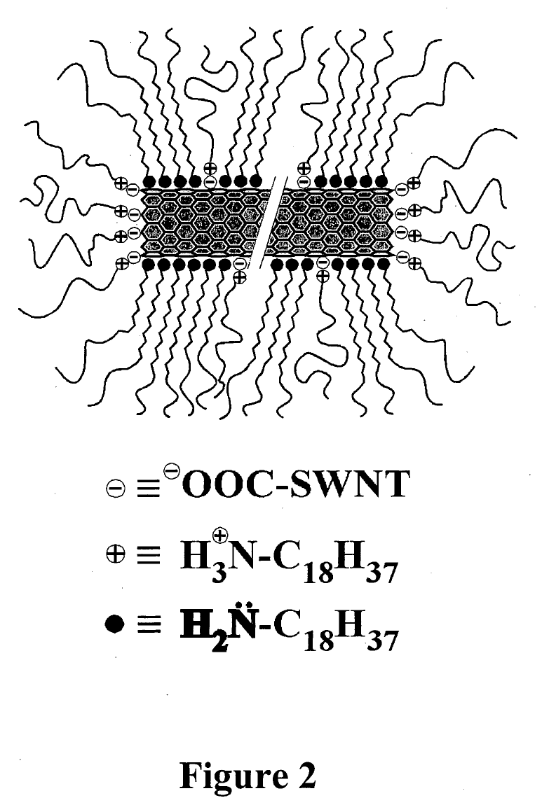

The zwitterion formation and physisorption of surfactant N-alkyl-amines on SWNTs is illustrated schematically in FIGS. 1 and 2. As shown in FIG. 1, the surfactant N-alkyl-amines may adhere to acid functionalized SWNTs forming zwitterions with the acid functionalities. These zwitterions are believed to form primarily at the ends of the SWNTs, although some zwitterions may form along the sides of the SWNTs due to nanotube defects, for example. Without being held to theory, it is believed that this occurs for both sem-SWNTs and met-SWNTs. As shown in FIG. 2, the surfactant N-alkyl-amines may also physisorb along the side walls of the SWNTs. This is believed to be primarily the case for sem-SWNTs. Also as shown in FIG. 2, the strong electrostatic and H-bonding environment of nearby amines favors the organization of the amine functionalities of the surfactant N-alkyl-amines along the walls of the SWNTs. If this occurs, then the amine functionalities of the surfactant amines will be flanked along one side by their aliphatic hydrocarbon chains thereby promoting solubilization along with preventing strong nanotube/amine/nanotube interactions. Without being held to theory, it is believed that the physisorption of surfactant amines along the sidewalls of sem-SWNTs coupled with the ordering of the amine functionalities, leads to improved solubilization of sem-SWNTs as compared with met-SWNTs. In summary, FIGS. 1 and 2 demonstrate that the sem-SWNTs and the met-SWNTs have different behavior when functionalized with surfactant amines. Thus, when a means for selective precipitation is added to the suspension of surfactant amine functionalized SWNTs, the met-SWNTs are precipitated while the sem-SWNTs remain in suspension.

In certain cases, it may be possible to separate sem-SWNTs from a non-acid functionalized population of SWNTs (sem- and met-). For example, when a population of SWNTs is annealed at a temperature of greater than or equal to about 300° C. (e.g., about 300 to about 400° C.), any existing carboxy functionalities are removed. The annealed SWNTs may then be contacted with a surfactant amine for a time and at a temperature sufficient to allow the surfactant amines to interact with the sem-SWNTs and form a population of surfactant amine functionalized sem-SWNTs. Contacting may be performed in the presence of a solvent such as for example, a high boiling point nonpolar solvent (i.e., having a boiling point of greater than 100° C.) such as, for example, toluene, chlorobenzene, dichlorobenzene, and combinations comprising one or more of the foregoing solvents. Sonication may optionally be employed during contacting. In order to extract a population of sem-SWNTs while leaving a population of met-SWNTs behind, a means for extraction is employed. Suitable means for extraction include contacting the SWNTs with a non-polar extraction solvent, preferably a nonpolar extraction solvent that has been saturated with the surfactant amine. Preferably the nonpolar extration solvent is a low boiling point extraction solvent (i.e, having a boiling point of less than or equal to 100° C.) such as, for example, THF, methylacetate, an ether acetate, a chlorinated hydrocarbon, and combinations comprising one or more of the foregoing solvents. The nonpolar extraction solvent may further comprise an agent that modifies a property of the means for solvent extraction, wherein the property is solvent polarity, ionic strength, redox potential, complexing efficiency, or combination comprising one or more of the foregoing properties. The solvent extraction may then be optionally followed by a nanotube dispersion cycle that renders the sem-SWNTs soluble and thus capable of being separated. The SWNT dispersion cycle may include filtration, centrifugation, sedimentation at high or low temperatures, and combinations comprising one or more of the foregoing treatments.

A method of selectively precipitating sem-SWNTs while leaving the met-SWNTs in the suspension comprises treating a suspension of carboxy functionalized SWNTs with a non-surfactant amine. When a means for selective precipitation is added to the suspension, sem-SWNTs are preferentially precipitated while a population of the met-SWNTs remains in suspension. The enrichment that may be achieved by this method is preferably greater than or equal to 2-fold enrichment of the soluble SWNT population for met-SWNTs, preferably greater than or equal to about 4-fold enrichment, more preferably greater than or equal to about 8-fold enrichment, and more preferably greater than or equal to about 100-fold enrichment.

Repeating the precipitation with a met-SWNT-enriched fraction may further improve the separation efficiency. By establishing an optimum acid functionalization content for both met- and sem-SWNTs, dispersion and thus the level of purification can be improved.

As shown in FIG. 2 and described in detail above, when SWNTs are functionalized with surfactant N-alkyl-amines, solubilization of sem-SWNTs is favored. If however, the SWNTs are treated with non-surfactant amines, precipitation of sem-SWNTs is favored. When the surfactant chains are substantially minimized or removed (e.g., low molecular weight amines), substituted with α,ω-alkyl- or alkyl/aryl-diamines, or are multifunctional amines, addition of these reagents to suspended sem- and met-SWNT mixtures should cause the sem-fraction to preferentially precipitate, thereby enriching the supernatant with met-SWNTs. Like the surfactant amines, the non-surfactant amines are expected to preferentially associate with the sem-SWNTs. Without being held to theory, it is believed that because the non-surfactant amines lack the long surfactant chain of the surfactant amines, their complexes with sem-SWNTs lack the one-side flank protection of the surfactant chain. The lack of a one-side flank protection (i.e., organization) as observed with the surfactant amines, allows the non-surfactant amines to preferentially interact with more than one sem-SWNT, which causes aggregation and the eventual precipitation of the aggregated sem-SWNTs, while the met-SWNTs remain in suspension. Thus, non-surfactant amines can be used as a means of selective precipitation of sem-SWNTs.

The selective precipitation method can also be employed to separate SWNTs by diameter. Based on the diameter-dependence energy separation of the Van Hove singularities, amines interact stronger with larger diameter (e.g., diameters of about 1.2 nm) sem-SWNTs than smaller diameter (e.g., diameters of about 0.8 nm) sem-SWNTs. A preferred amine is dimethylamine. Thus, the sem-SWNTs can be separated into a small diameter (about 0.8 to about 0.95 nm), an intermediate diameter (about 0.95 to about 1.05 nm), and a large diameter (about 1.05 to about 1.2 nm) fraction by adding non-surfactant amines to a population of acid functionalized SWNTs. The population of SWNTs to be separated by diameter is preferably enriched for sem-SWNTs. By enriched for sem-SWNTs, it is meant that the population comprises greater than or equal to about 66 wt % sem-SWNTs, more preferably greater than or equal to about 80 wt % sem-SWNTs, and most preferably greater than or equal to about 95 wt % sem-SWNTs. The small, intermediate, and large diameter fractions can further be subdivided into narrower diameter distribution fractions.

Furthermore, the selective precipitation of sem-SWNTs by diameter may be achieved with a means for selective precipitation other than an amine. Without being held to theory, it is believed that reagents other than amines interact differently with different diameter sem-SWNTs. Thus, by careful control of the time of reaction, temperature of reaction, and concentration of these reagents, selective precipitation of larger diameter sem-SWNTs can be achieved first, followed by successive precipitation of intermediate and then smaller diameter sem-SWNTs. In addition, the means for selective precipitation according to diameter may comprise heat, solution concentration, centrifugation speed, and combinations comprising one or more of the foregoing means. Suitable means for selective precipitation of sem-SWNTs according to diameter include, for example, those disclosed as useful in the method of selective precipitation of SWNTs by type.

A similar method may be employed to separate met-SWNTs on the basis of their diameter. A means of selective precipitation alters the solubility of the met-SWNTs according to their diameter. Suitable means for selective precipitation include those useful for separation of SWNTs by type. The met-SWNTs can be separated into a small diameter (about 0.8 to about 0.95 nm), an intermediate diameter (about 0.95 to about 1.05 nm), and a large diameter (about 1.05 to about 1.2 nm) fraction by adding non-surfactant amines to a population of acid functionalized SWNTs. The population of SWNTs is preferably enriched for met-SWNTs. By enriched for met-SWNTs, it is meant that the population comprises greater than or equal to about 66 wt % met-SWNTs, more preferably greater than or equal to about 80 wt % met-SWNTs, and most preferably greater than or equal to about 95 wt % met-SWNTs. The small, intermediate, and large diameter fractions can further be subdivided into narrower diameter distribution fractions.

Once a population of SWNTs is separated either by type or diameter, the population of single wall nanotubes may optionally be treated at temperatures of, for example, about 300° C. to about 400° C. to remove any acid and/or amine functionalities. Amine functionalities may also be removed by treatment with solvents such as chloroform, dimethyl formamide (DMF), dimethylsulfoxide and mixtures of thereof.

The disclosure is further illustrated by the following non-limiting Examples.

### EXAMPLES

### Example 1

### Octadecylamine (ODA) Functionalization of Acid Functionalized SWNTs

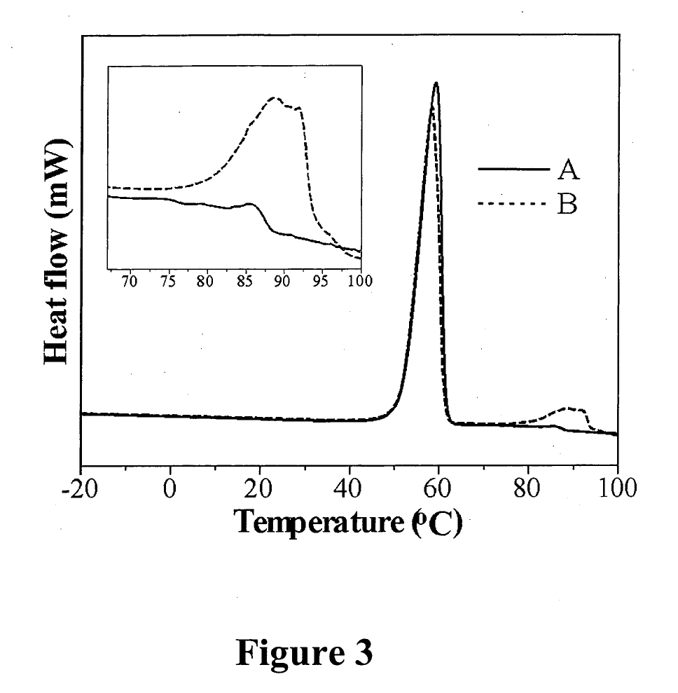

In order to understand the temperature-dependence of the surfactant N-alkyl-amine functionalization of SWNTs, the DSC profile of the pure surfactant N-alkyl-amine (ODA) was studied. Although the melting point of ODA is about 58° C., differential scanning calorimetry (DSC, scan rate of 5° C./minute) and cross-polar optical microscopy indicate the presence of a higher melting endotherm at about 87° C., as shown in FIG. 3A. Heating ORA for 18 hours at 68° C. or higher resulted in an enthalpy increase of the higher melting endotherm (FIG. 3B) and a shift of its maximum to higher temperature (e.g., about 92° C.), indicative of a gradual ordering of the higher melting phase.

Acid treated HiPco™ (having diameter (d) distribution between about 0.8 to about 1.3 nm and d_{AVG} of about 1 nm) and laser ablated (with diameter distribution between about 1.15 to about 1.55 nm and d_{AVG} of about 1.37 nm) SWNTs were dispersed in THF by the zwitterion route. Both met- and sem-SWNTs were dispersed by this treatment, yielding a transparent and heavily colored solution stable at concentrations between about 0.5 to about 1 mg/mL. In order to improve the yield of functionalization of acid treated SWNTs by ODA and their subsequent dispersion in THF, temperatures in excess of 90° C. may be employed. Thus, performing functionalization at temperatures approaching or greater than the higher melting endotherm were employed to improve the solubilization of the SWNTs and the subsequent separation by type and/or diameter.

The thermal behavior of the resulting SWNT/ODA complexes was studied. Thermogravimetric analysis indicated a significant weight loss (more than 90%, results not included) at 150 to 450° C., pointing the strong ODA physisorption along the SWNT sidewalls. This significant weight loss demonstrated that the SWNTs are substantially coated with the surfactant N-alkyl-amine as illustrated schematically in FIG. 2.

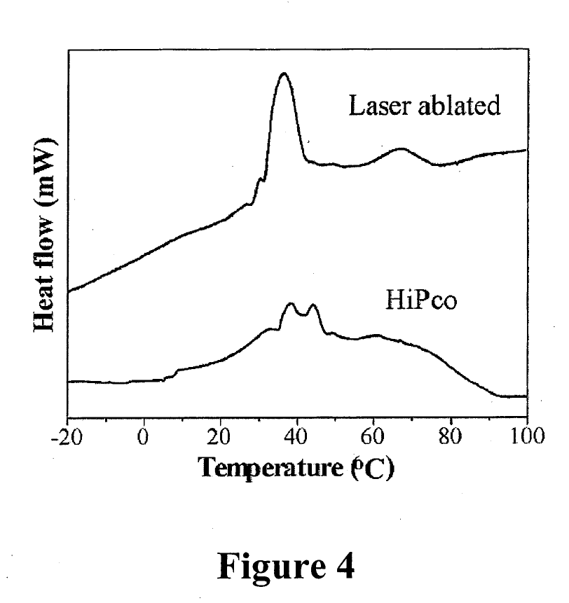

FIG. 4 shows the DSC of the surfactant N-alkyl-amine coating the SWNTs. The presence of broad endothermic melting transitions associated with the SWNT/ODA complexes, for both HiPco and laser-ablated SWNTs extended all the way up to 92° C., the melting temperature of the higher melting phase of ODA. Thus, the ODA is clearly associated with the SWNTs for both HiPco and laser-ablated SWNTs.

### Example 2

### Bulk Separation of Semiconducting from Metallic SWNTs from ODA-suspended HiPco SWNT samples in THF

HiPco SWNTs were carboxy-functionalized by a brief sonication-assisted oxidation in a mixture of H₂SO₄ and HNO₃ following a previously established protocol (J. Liu et al. Science, 280:1253, 1998; D. Chattopadhyay et al., Carbon, 60:960, 2002). The noncovalent functionalization of SWNTs with octadecylamine (ODA) involved a treatment of the carboxy-functionalized SWNTs in molten ODA at temperatures of 90° C. to 120° C. for 120 hours followed by extensive sonication-assisted washing with ethanol to remove free ODA. The resulting solid was then dispersed in THF via mild sonication, followed by filtration through coarse filter paper to remove the undispersed SWNTs, with typical yields of about 75% dispersed SWNTs. Accelerated precipitation of met- from sem-SWNTs was achieved via solvent evaporation by immersing the ODA/SWNTs/THF dispersion in a preheated water bath (60° C.) at ambient pressure. The gradual precipitation of the destabilized SWNT fraction was accelerated by centrifugation.

The resonance Raman spectra of the as-supplied, supernatant and precipitate ODA-functionalized SWNTs were obtained from free-standing or drop-cast SWNT fractions on quartz substrates with thicknesses exceeding about 1 μm. The strong coupling between electrons and photons, arising from the 1-D confinement-induced Van Hove singularities in the density of states (DOS) for SWNTs, gives rise to highly unusual diameter dependent resonance Raman spectra, reflected by the radial breathing mode (RBM) (e.g., about 100-300 nm for SWNTs used in the current study) profiles (A. M. Rao et al., Science 275:187, 1997). Resonance conditions apply when the energy of the incident and/or the scattered photons matches an interband electronic transition of the SWNTs and is typically within ±0.1 eV of the laser excitation energy (Elaser). Additionally, the distinct differences in the line shape of the tangential G-band (e.g., about 1500-1605 cm⁻¹) provided a simple method for distinguishing between met-SWNTs and sem-SWNTs (M. A. Pimenta et al., Phys. Rev. B. 58:R16016, 1998). Typically, the G-band of sem-SWNTs has two distinct Lorentzian peaks (e.g., about 1592 cm⁻¹ and about 1567 cm⁻¹) with relatively narrow line widths. The peak at about 1592 cm⁻¹ is associated with vibrations along the SWNT axis (ω⁺_{G}), while the peak at about 1567 cm⁻¹ has been attributed to vibrations along the tangential direction (ω⁻_{G}). Although, the ω⁺_{G} component of met-SWNTs has a Lorentzian lineshape that is almost as narrow as that for sem-SWNTs, the ω⁻_{G} constituent is broad and best described by a Breit-Wigner-Fano (BWF) line shape (S. D. M. Brown et al., Phys. Rev. B. 63:15414, 2001).

The lower left panel of FIG. 4 provides an illustration of the expected resonance windows for the different diameters present in HiPco SWNTs for both met- and sem-SWNTs, upon excitation at 514.5 nm (2.41 eV) depicted by the horizontal gray bar. The lower-left panel shows the correlation between electronic transition energy Eᵢᵢ (i.e. ^{S}E₃₃, ^{M}E₁₁, ^{S}E₂₂ from left to right, with semiconducting (solid circles) and metallic (crosses)) versus RBM frequencies of top left panel. The top of the horizontal gray band illustrates the Eₗₐₛₑᵣ=2.41 eV broadened by the scattered phonon (Eₚₕₒₙₒₙ about 0.1-0.2 eV) for Stokes Raman spectra (E=Eₗₐₛₑᵣ−Eₚₕₒₙₒₙ).

The separation by type is evident by: (a) observing at the right panel the different line shapes of the G-band and the stars, which indicate the location of the broad ω⁻_{G} component of met-SWNTs best described by Breit-Winger-Fano (BWF) line shape, and (b) by the vertical band at both left panels, correlating the RBM peaks (top) with the corresponding Eᵢᵢ transitions (bottom) (S for sem-SWNT and M for met-SWNTs) within the horizontal resonance band of the laser. Based on the diameter distributions of HiPco, the 2.41 eV excitation mostly probes met-SWNT and very few sem-SWNTs arising from the Eₗₐₛₑᵣ overlap with ^{S}E₃₃ transitions for larger diameter (1.27-1.15 nm) sem-SWNTs.

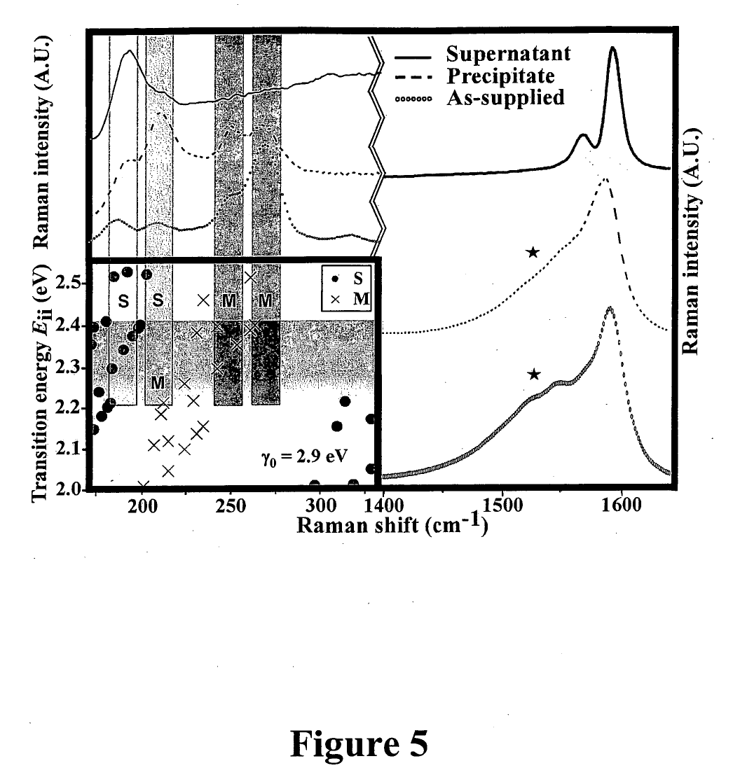

If the hypothesis that a population of the sem-SWNTs remains suspended is correct, the RBM profile of the precipitate sample should be similar to that of as-supplied sample, whereas the SWNTs remaining in the supernatant should be dramatically different. This is amply demonstrated in FIG. 5 (top left panel), where the supernatant exhibits a single broad peak at about 190 nm (diameter about 1.27 nm), as discussed above. Additionally, a comparison of the G-bands in FIG. 4 (right panel), for all three samples revealed significant qualitative differences. The sharp ω⁺_{G} (about 1592 cm⁻¹) and ω⁻_{G} (about 1567 cm⁻¹), characteristics of sem-SWNTs, exhibited by the supernatant SWNT fraction as opposed to the as-supplied and precipitate fractions indicated substantial separation of sem-SWNTs from their metallic counterparts. This conclusion is also supported by the G-bands of the as-supplied and precipitate fractions that exhibited the typical BWF line shapes attributed to met-SWNT.

### Example 3

### Bulk Separation of Semiconducting from Metallic SWNTs from Laser-Ablated SWNT Samples

Laser-ablated SWNTs were carboxy-functionalized and ODA functionalized as in Example 2. The yields of suspended SWNTs was about 50% for laser-ablated SWNTs. Accelerated precipitation of met- from sem-SWNTs was achieved by solvent evaporation as in Example 2.

The relatively narrow 1.37±0.18 nm diameter distribution of laser-ablated SWNTs provides very few small diameter (e.g., less than 1.20 nm) met-SWNTs that can be probed by a 514.5 nm (2.41 eV) laser. For this experiment, the 785 nm (1.58 eV) excitation was utilized in both the Stokes (Eₗₐₛₑᵣ−Eₚₕₒₙₒₙ˜1.38 eV) and the anti-Stokes (Eₗₐₛₑᵣ+Eₚₕₒₙₒₙ˜1.78 eV) regime to probe sem-SWNTs with diameters smaller than 1.20 nm and met-SWNTs with diameters larger than 1.40 nm, respectively. Typically, in the anti-Stokes Raman spectra an additional enhancement of the vibrational features for met-SWNTs has been observed experimentally relative to sem-SWNTs on account of their stronger electron-photon coupling (S. D. M. Brown et al., Phys. Rev. B. 61:R5137, 2000).

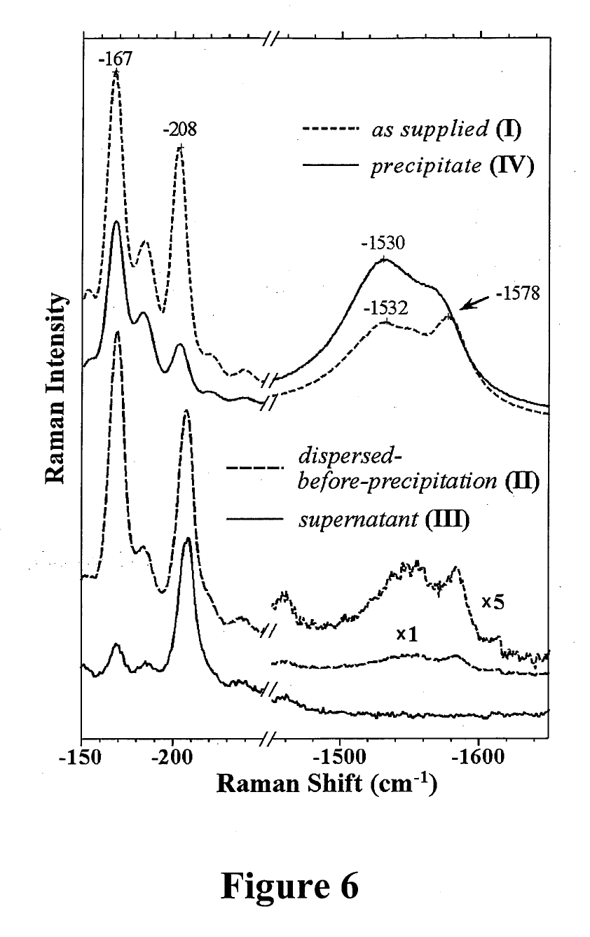

FIG. 6 depicts the anti-Stokes spectra of the as-supplied (I), dispersed-before-precipitation (II), supernatant (III), and precipitate (IV) fractions for the laser-ablated SWNTs following the complete removal of any ODA and THF residues. The −167 and −208 cm⁻¹ RBM peaks were characteristic of large-diameter (about 1.46 nm) metallic and small-diameter (about 1.14 nm) semiconducting SWNT, respectively. As anticipated, the broad BWF lineshape typical for met-SWNTs was evident in the anti-Stokes spectra of IV and I, while that for II appeared to be significantly subdued by at least a factor of five as shown in the ×5 inset appended for spectral clarity. Interestingly, in IV the G-band has a significantly broadened BWF line shape, with a single dominant ω⁻_{G} component centered at about 1530 cm⁻¹ as opposed to I (M. A. Pimenta et al., Phys. Rev. B. 58:R16016, 1998), pointing to enrichment of the precipitate with met-SWNTs. A comparison of the RBM profiles for I and II indicated qualitative similarities, with two sharp features at −208 and at −167 cm⁻¹ with the latter emerging as the strongest feature. The RBM peak at −167 cm⁻¹ can be attributed to met-SWNTs (diameter about 1.46 nm, ^{M}E₁₁=1.71 eV), while the feature at −208 cm⁻¹ corresponded to sem-SWNTs (diameter about 1.14 nm, ^{S}E₂₂=1.46 eV) (D. Chattopadhyay, et al. J. Am. Chem. Soc 125:3370, 2003). Interestingly, in the spectrum for IV (i.e., precipitated SWNTs), the contribution from the −208 cm⁻¹ component is significantly subdued, pointing to an enrichment of the precipitate with met-SWNTs and in accordance with the lineshape changes of the G-band. This complimented the spectrum for III (supernatant) where a dramatic decrease in intensity of the −167 cm⁻¹ peak became apparent, with the peak at −208 cm⁻¹ appearing as the dominant component, indicating that sem-SWNT were retained in solution.

### Example 4

### Effect of the SWNT/Surfactant-Amine Heating Conditions to the Bulk Separation of Semiconducting from Metallic SWNTs

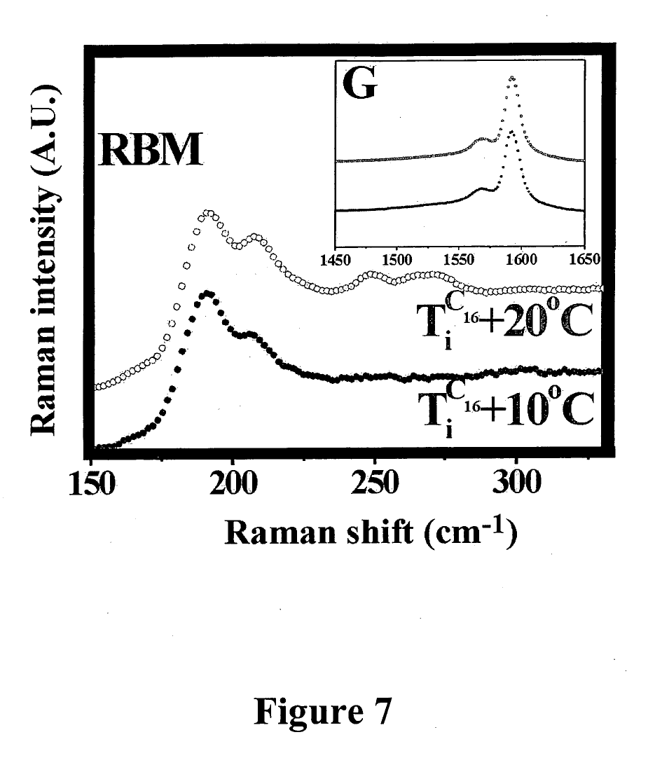

It is possible that surfactant N-alkyl-amine organization around the walls of SWNTs contributes to the stability of SWNT/surfactant amine complexes. This organization may be affected by the temperature of surfactant N-alkyl-amine functionalization as shown in Example 1. Thus, the relationship between the separation efficiency and the temperature that the SWNTs are subjected to during amine functionalization was determined. Acid functionalized SWNTs were heated with molten phases of hexadecyl amine (HDA) (C₁₆H₃₃—NH₂) instead of octadecyl amine ODA (C₁₈H₃₇—NH₂) in order to decrease slightly the temperature of the higher melting point transition and to provide a larger annealing window before amine oxidative degradation occurs (e.g., usually about 110 to about 120° C. in the presence of oxygen). The clearing or isotropization temperature (TiCn) for HDA is 86° C. as opposed to 92° C. for ODA. FIG. 7 illustrates the 514 nm, 2.41 eV resonance Raman spectra of the radial breathing mode (RBM) (bottom curves) and G-band (insert) of supernatant separated fractions of HiPco SWNTs that have previously been annealed for 96 hours in HDA at temperatures of Tᵢ^{C}^{₁₆}+10° C. (96° C.) and Tᵢ^{C}^{₁₆}+20° C. (106° C.), respectively. As evidenced by the RBM Raman curves, the sample functionalized at 96° C. exhibits better sem-SWNT separation as compared to the sample functionalized at 106° C., which exhibits a significant amount of met-SWNT impurities based on the presence of the 250 and 270 cm⁻¹ peaks. Similar behavior is observed if the SWNTs are surfactant N-alkyl-amine functionalized at temperatures far lower than the higher melting transition of the surfactant N-alkyl-amine. These results demonstrate the effect of surfactant N-alkyl-amine functionalization of SWNTs within the vicinity of the higher melting point transition of these and related surfactant N-alkyl-amines.

### Example 5

### Bulk Separation of Metallic from Semiconducting SWNTs

As shown in Example 2, the natural tendency of SWNTs to aggregate may contaminate the precipitate with sem-SWNT impurities, which co-precipitate with met-SWNTs. Thus, the precipitate may not comprise only met-SWNTs. For this reason, another methodology was developed to preferentially precipitate sem-SWNTs, leaving met-enriched SWNTs preferentially in the supernatant fraction.

HiPco SWNTs were carboxy-functionalized as described in Example 2 and dispersed in dimethylformide (DMF) via mild sonication, followed by filtration through coarse filter paper to remove undispersed SWNTs. The selective precipitation of sem-SWNTs was achieved by the slow addition under stirring of small amounts of dimethylamine. Then the resulting suspension was allowed to stand over prolonged periods of time. The gradual precipitation of the destabilized SWNT fraction can be further accelerated by centrifugation.

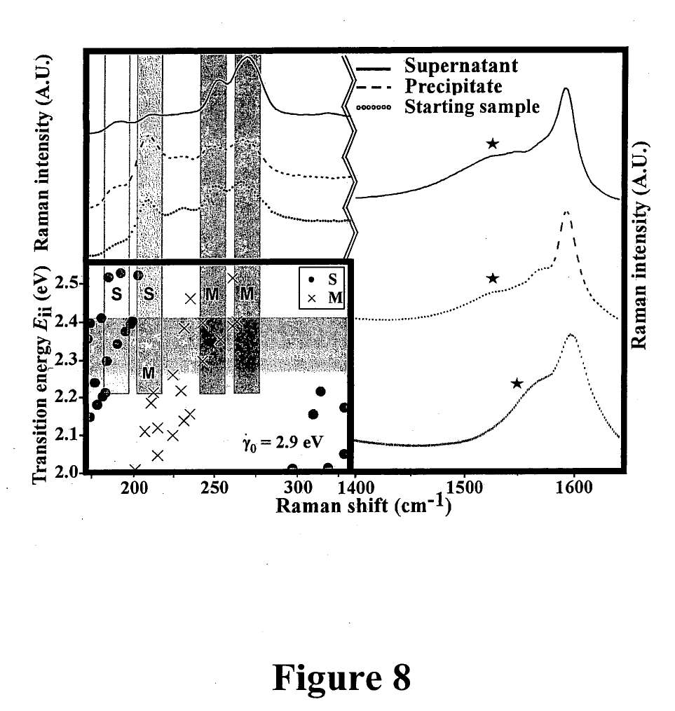

FIG. 8 illustrates the 514 nm resonance Raman spectra of the starting sample (acid-treated and annealed to remove acidic-doping functionalities), precipitate and supernatant fractions of HiPco SWNTs, following the complete removal of the added dimethylamine and any remaining dimethylformamide (DMF) solvent residues. When compared with FIG. 4, precipitation of the sem-SWNTs leaving suspended the met-SWNTs was observed. This precipitation of sem-SWNTs was evident from the RBM Raman region (FIG. 8, top-left panel) where the 257 and 270 cm⁻¹ peaks assigned to met-SWNTs are significantly more prominent in the supernatant as oppose to the precipitate and the starting sample. Moreover, the G-band of FIG. 8 (right panel) indicates that the characteristic BWF-shaped metallic ω⁻_{G} peak, denoted with an asterisk is more prominent for the supernatant as oppose to the precipitate and the starting sample. The behavior is attributed to the fact that dimethyl-amine is a small amine and by lacking the one-side flank protection of the surfactant chain causes it to preferentially interact with more than one sem-SWNT, which causes aggregation and their eventual precipitation.

### Example 6

### Bulk Separation of Semiconducting SWNTs According to Diameter

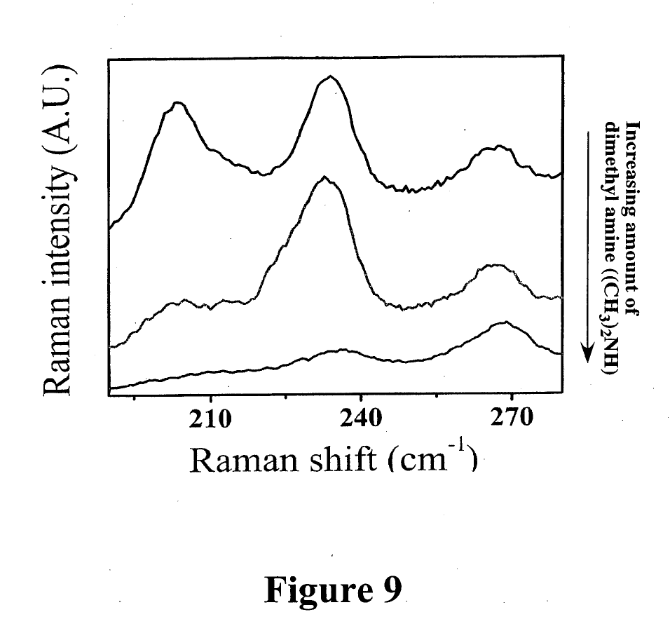

The careful introduction of various reagents (e.g., non-surfactant amines, acids, salts, non-solvents, and the like) can affect the differential precipitation of either sem-SWNTs or met-SWNTs. This approach can also be used for diameter-selective enrichment and separation of SWNTs, for example for differential precipitation of larger diameter sem-SWNTs. A sem-enriched SWNT HiPco sample (about 80% sem-SWNTs), prepared as described in Example 2, was dispersed in DMF. Dimethylamine was slowly added to the dispersion. FIG. 9 illustrates the radial breathing mode (RBM) Raman spectra of the supernatant for DMF-dispersed HiPco SWNTs for increasing amounts of added dimethylamine. The excitation laser (785 nm or 1.58 eV) is resonant only with the second pair of singularities (^{S}E₂₂) of the semiconducting SWNTs, and thus provided a qualitative account of what diameter (dₜ) sem-SWNTs are suspended at each point. The dₜ values were obtained from the Raman frequency shift (ω_{RBM}) according to the formula ω_{RBM}=α/dₜ+β. The coefficients α and β are sensitive to the SWNT synthesis method and SWNT surroundings. For HiPco SWNTs, α=239 cm⁻¹ nm and β=8.5 cm⁻¹ were obtained by fitting data for many laser lines (A. Kukovecz et al., Eur. Phys. J B 28:223, 2002). Using these values, the three major peaks (at 203, 235, and 267 cm⁻¹) corresponded to 1.23, 1.06, 0.924 nm SWNTs. As shown in FIG. 9, the progressive addition of dimethylamine first caused the gradual precipitation of the larger (1.23 nm) SWNTs. This was then followed by the precipitation of the intermediate diameter (1.06 nm) SWNTs, leaving a supernatant that was rich with the smaller observable diameter (0.924 nm) SWNTs. Similar results were obtained by collecting the supernatant at various times, indicating that this is a gradual process that favor first the precipitation of larger diameter SWNTs.

While preferred embodiments have been shown and described, various modifications and substitutions may be made thereto without departing from the spirit and scope of the invention.

What is claimed is:

1. A method of separating met-SWNTs from sem-SWNTs, the method comprising:
suspending a population of functionalized SWNTs in a suspending solvent, and employing a means for inducing selective precipitation, wherein selective precipitation comprises precipitating a majority of the met-SWNTs while leaving a population of the sem-SWNTs in suspension, or precipitating a majority of the sem-SWNTs while leaving a population of the met-SWNTs in suspension.

2. The method of claim 1, wherein the SWNTs are single walled carbon nanotubes.

3. The method of claim 1, further comprising functionalizing a population of SWNTs prior to suspending the population of functionalized SWNTs, wherein functionalizing comprises:
treating a population of SWNTs with a functionalizing agent, and
heating at a temperature and time sufficient to associate the functionalizing agent with the SWNTs.

4. The method of claim 3, wherein the functionalizing agent comprises an acid, a surfactant amine, or a combination comprising one or more of the foregoing agents.

5. The method of claim 1, wherein the population of functionalized SWNTs comprises an acid functionality and a surfactant amine functionality, and wherein selective precipitation comprises precipitating the majority of the met-SWNTs while leaving the population of the sem-SWNTs in suspension.

6. The method of claim 5, wherein the surfactant amine functionality is octadecylamine, butylamine, sec-butylamine, tert-butylamine, pentylamine, hexylamine, heptylamine, octylamine, nonylamine, decylamine, dodecylamine, tetradecylamine, hexadecylamine, eicosadecylamine, tetracontylamine, pentacontyl-amine, 10,12-pentacosadiynoylamine, 5,7-eicosadiynoylamine, benzyl amine, aniline, phenethyl amine, N-methylaniline, N,N-dimethylaniline, 2-amino-styrene, 4-pentylaniline, 4-dodecylaniline, 4-tetradecylaniline, 4-pentacosylaniline, 4-tetracontylaniline, 4-pentacontylaniline, or a combination comprising one or more of the foregoing amines.

7. The method of claim 5, wherein the suspending solvent comprises an ether, an acetate, an aliphatic hydrocarbon, an aromatic hydrocarbon, a chlorinated solvent, or a combination comprising one or more of the foregoing solvents.

8. The method of claim 5, wherein the means for inducing selective precipitation comprises centrifuging the suspension, increasing the temperature of the suspension, decreasing the temperature of the suspension, increasing the concentration of the functionalized nanotubes in the suspension, evaporating the suspending solvent in the suspension, adding a non-solvent to the suspension, adding a compound with a high dielectric constant to the suspension, adding an ionic compound to the suspension, adding a non-polar agent to the suspension, adding a complexing cation to the suspension, adding a reducing agent to the suspension, adding an oxidizing agent, or a combination comprising one or more of the foregoing means.

9. The method of claim 1, wherein the functionalized SWNTs comprise an acid functionality, and wherein selective precipitation comprises precipitating the majority of the sem-SWNTs, while leaving the population of the met-SWNTs in suspension.

10. The method of claim 9, wherein the means for inducing selective precipitation comprises adding a non-surfactant amine to the suspension, centrifuging the suspension, increasing the temperature of the suspension, decreasing the temperature of the suspension, increasing the concentration of the functionalized nanotubes in the suspension, evaporating the suspending solvent in the suspension, adding a non-solvent to the suspension, adding a compound with a high dielectric constant to the suspension, adding an ionic compound to the suspension, adding a non-polar agent to the suspension, adding a complexing cation to the suspension, adding a reducing agent to the suspension, adding an oxidizing agent, or a combination comprising one or more of the foregoing means.

11. The method of claim 10, wherein the non-surfactant amine is ammonia, methylamine, ethylamine, propylamine, isopropylamine, butylamines, N,N-dimethylamine, N,N-methylethylamine, N,N-diethylamine, N,N-ethylpropylamine, N,N-dipropylamine, ethyleneamine, propyleneamine, butyleneamine, pentyleneamine, hexyleneamine, heptyleneamine, octyleneamine, nonyleneamine, decyleneamine, dodecyleneamine, tetradecyleneamine, hexadecyleneamine, eicosadecyleneamine, tetracontyleneamine, pentacontyleneamine, 10,12-pentacosadiynoylene-α,ω-diamine, 5,7-eicosadiynoylene-α,ω-diamine, piperazine, 1,4-phenylenediamine, p-xylylenediamine, pentaethylenehexamine, triethylenetetraamine, N,N′-bis(3-aminopropyl)-1,3-propanediamine, N,N′-bis(3-aminopropyl)-1,3-butanediamine, or a combination comprising one or more of the foregoing amines.

12. The method of claim 9, wherein the suspending solvent comprises a polar solvent.

13. The method of claim 12, wherein the polar solvent is dimethylformamide, dimethylacetamide, formamide, methyl formamide, hexamethylenephosphormamide, dimethylsulfoxide, or a combination comprising one or more of the foregoing polar solvents.

14. A method for selective extraction of sem-SWNTs from a mixture of sem-SWNTs and met-SWNTs, comprising
contacting a population of non-acid functionalized SWNTs with an surfactant amine, to form a population of surfactant amine functionalized sem-SWNTs and
extracting the population of surfactant amine functionalized sem-SWNTS with a means for solvent extraction while leaving a majority of the met-SWNT behind.

15. The method of claim 14, wherein the means for solvent extraction comprises contacting the sem-SWNTs with a nonpolar solvent saturated with a surfactant amine.

16. The method of claim 15, wherein the nonpolar solvent is an ether, an acetate, an aliphatic hydrocarbon, an aromatic hydrocarbon, a chlorinated solvent, or a combination comprising one or more of the foregoing solvents.

17. The method of claim 15, wherein the nonpolar solvent further comprises an agent that modifies a property of the means for solvent extraction, and wherein the property is solvent polarity, ionic strength, redox potential, complexing efficiency, or a combination comprising one or more of the foregoing properties.

18. The method of claim 14, further comprising employing a naonotube dispersion selected from filtration, centrifugation, sedimentation at high or low temperatures, or a combinations thereof.

19. A method of separating sem-SWNTs or met-SWNTs by diameter to form a diameter-separated population of sem-SWNTs or met SWNTs, comprising
suspending an enriched population of functionalized sem-SWNTs or an enriched population functionalized met-SWNTs in a suspending solvent to form a functionalized sem-SWNT suspension or a functionalized met-SWNT suspension, and
employing a means for selectively precipitating according to diameter the functionalized sem-SWNTs or functionalized met-SWNTs,
wherein the enriched population of functionalized sem-SWNTs comprises greater than or equal to about 66 wt % sem-SWNTs or the enriched population of functionalized met-SWNTs comprises greater than or equal to about 66 wt % met-SWNTs.

20. The method of claim 19, wherein the means for selectively precipitating according to diameter comprises a non-surfactant amine to the suspension, centrifuging the suspension, increasing the temperature of the suspension, decreasing the temperature of the suspension, increasing the concentration of the functionalized nanotubes in the suspension, evaporating the suspending solvent in the suspension, adding a non-solvent to the suspension, adding a compound with a high dielectric constant to the suspension, adding an ionic compound to the suspension, adding a non-polar agent to the suspension, adding a complexing cation to the suspension, adding a reducing agent to the suspension, adding an oxidizing agent, or a combination comprising one or more of the foregoing means.

21. The method of claim 20, wherein the non-surfactant amine is ammonia, methylamine, ethylamine, propylamine, isopropylaamine, butylamines, N,N-dimethylamine, N,N-methylethylamine, N,N-diethylamine, N,N-ethylpropylamine, N,N-dipropylamine, ethyleneamine, propyleneamine, butyleneaamine, pentyleneamine, hexyleneamine, heptyleneamine, octyleneamine, nonyleneamine, decyleneamine, dodecyleneamine, tetradecyleneamine, hexadecyleneamine, eicosadecyleneamine, tetracontyleneamine, pentacontyleneamine, 10,12-pentacosadiynoylene-α,ω-diamine, 5,7-eicosadiynoylene-α,ω-diamine, piperazine, 1,4-phenylenediamine, p-xylylenediamine, pentaethylenehexamine, triethylenetetraamine, N,N′-bis(3-aminopropyl)-1,3-propanediaamine, N,N′-bis(3-aminopropyl)-1,3-butanediamine, or a combination comprising one or more of the foregoing amines.

22. The method of claim 19, wherein the suspending solvent comprises a polar solvent.

23. The method of claim 19, wherein the polar solvent is dimethylformamide, dimethylacetamide, formamide, methyl formamide, hexamethylenephosphormamide, dimethylsulfoxide, or a combination comprising one or more of the foregoing polar solvents.
